(19) United States
(12) Patent Application Publication
(10) Pub. No.: US 2012/0107549 A1
(43) Pub. Date: May 3, 2012

(54) SMART SURFACES WITH TEMPERATURE INDUCED SOLAR REFLECTANCE CHANGES AND MAKING METHODS

(75) Inventors: Qingwu Wang, Chelmsford, MA (US); Guiquan Pan, Woburn, MA (US); Bin Zhao, Newton, MA (US)

(73) Assignee: Agiltron, Inc., Woburn, MA (US)

(21) Appl. No.: 13/284,273

(22) Filed: Oct. 28, 2011

Related U.S. Application Data
(60) Provisional application No. 61/344,874, filed on Nov. 1, 2010.

(51) Int. Cl. B32B 27/34; B32B 7/12; B05D 5/06; C09K 9/02; B32B 3/02; B32B 38/00; B82Y 30/00

(52) U.S. Cl. 428/76; 428/474.4; 156/146; 427/162; 252/583; 977/779

(57) ABSTRACT

Devices using thermochromic materials, where the thermochromic materials are stable for long time exposure to UV light and heat, have higher index of refraction, can be produced cost-effectively at large scale for large surface coating, allow convenient installation and a fast color switch are disclosed hereinbelow. Also disclosed are methods of use and fabrication.

### CROSS REFERENCE TO RELATED APPLICATIONS

This application claims priority to U.S. Provisional Application Ser. No. 61/344,874, filed Nov. 1, 2010, entitled, “SMART SURFACES WITH TEMPERATURE INDUCED SOLAR REFLECTANCE CHANGES AND MAKING METHODS,” which is incorporated by reference herein in its entirety for all purposes.

### BACKGROUND

This invention relates generally to thermochromic materials, and, more particularly, to thermochromic materials sensitive to the environment.

The world is facing disruptive global climate change from greenhouse gas emissions and increasingly expensive and scarce energy supplies. Energy efficiency reduces those emissions and mitigates the rising cost of energy. Cool changing roofing—a new technology that allows high reflectance in summer and low reflectance in winter to reduce a home's energy and peak electric demand for air conditioning and heating—promises a significant leap in energy efficiency.

Non-color changing roofing is suitable for extremely hot or cold areas, like white roofs for areas that are always hot and sunny, and black roofs for areas where it's always cold and sunny. While there are many regions in the world that are in these two categories, there are large areas that are in between those two extremes. The color changing surfaces disclosed in this invention would be applicable on the roofs in these “in-between” areas.

A number of thermochromic technologies, mainly based on liquid crystals and leuco dyes, have been used for different applications such as thermal printing, battery capacity marker, and drinking temperature indicator. However, they cannot be directly applied on roof-tops due to lacking of long time durability and low fabrication coat required by the roof-coating industries. Both of liquid crystals and leuco dyes are complex conjugated organic molecules. One difficulty with these organic molecules, liquid crystals and leuco dyes, is that they will quickly degrade with heat and UV exposure. Moreover, these materials have not been produced cost-effectively as roof coating materials.

There is a need materials that are stable for long time exposure to UV light and heat.

For liquid crystals and leuco dyes based thermochromic surface, the index of refraction of liquid crystals is smaller than 2. There is a need for materials that have higher index of refraction.

For liquid crystals and leuco dyes based thermochromic surface, these materials have not been produced cost-effectively at large scale for large surface coating such as roof coating materials. There is a need for materials that can be produced cost-effectively at large scale for large surface coating.

In liquid crystals and leuco dyes based thermochromic surface, normally several thin layers, including conductive layer and thermochromic layer, need to be deposited by special techniques and require an electric power to operate the switch. There is a need for materials that allow convenient installation and a fast color switch.

### BRIEF SUMMARY

Embodiments of devices using thermochromic materials, where the thermochromic materials are stable for long time exposure to UV light and heat, have higher index of refraction, can be produced cost-effectively at large scale for large surface coating, allow convenient installation and a fast color switch are disclosed hereinbelow. Also disclosed are methods of use and fabrication.

In one embodiment of the apparatus of these teachings, the apparatus of these teachings includes a first layer, a second layer; the second layer being disposed a distance apart from the first layer and a solution of thermosensitive polymer and high refractive index nanoparticles functionalized with the thermosensitive polymer, the thermosensitive polymer exhibiting a thermoresponsive phase transition at a predetermined temperature, the solution being disposed in a space defined by the distance between the first layer and the second layer, the predetermined temperature being a temperature resulting from conduction/absorption of electromagnetic radiation in one of the first layer, the second layer or the solution, at least one layer from the first and second layers being substantially transparent.

In one embodiment, the method of these teachings for changing reflectance of structures includes providing a structure, the structure being as described in the hereinabove disclosed device embodiment, and exposing the structure to an environment including sunlight; the solution of thermosensitive polymer and functionalized high refractive index nanoparticles undergoing a phase transition when the temperature of solution reaches the predetermined temperature, the phase transition converting the solution from substantially transparent to substantially reflecting due to scattering.

One embodiment of the formulation of these teachings includes a solvent, a thermosensitive polymer and high refractive index nanoparticles functionalized with the thermosensitive polymer, the thermosensitive polymer and high refractive index nanoparticles being in solution in the solvent; the thermosensitive polymer exhibiting a thermoresponsive phase transition at a predetermined temperature; the predetermined temperature being a temperature obtainable by from exposing, to an environment including sunlight, the solution, and a polymeric resin, the formulation being adapted for deposition onto a surface.

In another embodiment of the apparatus of these teachings, the apparatus is a thermochromic coated object and the thermochromic coated object (in one instance, these teachings not limited only to that instance, the object is a roof) includes an article, a surface of the article constituting a substrate, and a thermochromic coating applied to the substrate, the thermochromic coating resulting from the embodiment of the formulation disclosed hereinabove.

In one embodiment, the method of these teachings for changing reflectance of an object includes providing a thermochromic coated object comprising an article, a surface of the article constituting a substrate, and a thermochromic coating applied to the substrate, the thermochromic coating resulting from the formulation described in the hereinabove disclosed formulation embodiment, and exposing the structure to an environment including sunlight; the solution of thermosensitive polymer and functionalized high refractive index nanoparticles in the formulation undergoing a phase transition when the temperature of the solution reaches the predetermined temperature, the phase transition converting the solution from substantially transparent to substantially reflecting due to scattering.

In one embodiment, the method of these teachings for fabricating an object that changes reflectance includes applying to a surface of an article, the surface constituting a substrate, the formulation described in the hereinabove disclosed formulation embodiment, and drying the applied formulation in order to form a coating on the substrate.

Various other embodiments and instances are also disclosed hereinbelow.

For a better understanding of the present teachings, together with other and further objects thereof, reference is made to the accompanying drawings and detailed description and its scope will be pointed out in the appended claims.

### BRIEF DESCRIPTION OF THE DRAWINGS

FIGS. 1a, 1b are graphical schematic representations of operation of one embodiment of the device of these teachings;

FIG. 2 is a graphical schematic representation of an embodiment of the device of these teachings;

FIG. 3 is a graphical schematic representation of a 3-D view of an embodiment of the device of these teachings;

FIG. 4 is a graphical schematic representation of an embodiment of the device of these teachings;

FIG. 5 is a graphical schematic representation of an embodiment of the method for fabricating an embodiment of the nanoparticle/polymer fluid based thermochromic cell device of these teachings;

FIG. 6 is a graphical schematic representation of a thermochromic coated object of these teachings;

FIG. 7 is a graphical schematic representation of results for one embodiment of the nanoparticle/polymer fluid used in these teachings; and

FIG. 8 represents a graphical schematic representation of results for temperature dependence of the reflectivity of a front surface of the thermochromic device of these teachings.

### DETAILED DESCRIPTION

The following detailed description is of the best currently contemplated modes of carrying out these teachings. The description is not to be taken in a limiting sense, but is made merely for the purpose of illustrating the general principles of these teachings, since the scope of these teachings is best defined by the appended claims. Although the teachings have been described with respect to various embodiments, it should be realized these teachings are also capable of a wide variety of further and other embodiments within the spirit and scope of the appended claims.

As used herein, the singular forms “a,” “an,” and “the” include the plural reference unless the context clearly dictates otherwise.

Except where otherwise indicated, all numbers expressing quantities of ingredients, reaction conditions, and so forth used in the specification and claims are to be understood as being modified in all instances by the term “about.”

To assist in the understanding of the present teachings the following definitions are presented.

As used herein, a “formulation” is a liquid carrier medium, as defined above, comprising at least one material either dissolved and/or distributed within said liquid carrier medium.

As used herein, a “thermochromic formulation” is a formulation, as defined above, which additionally includes thermosensitive polymer and high refractive index nanoparticles functionalized with the thermosensitive polymer, the thermosensitive polymer exhibiting a thermoresponsive phase transition at a predetermined temperature.

As used herein, “high refractive index” is a refractive index greater than about 1.7.

As used herein, a “thermochromic coating” is a coating resulting from at least one thermochromic formulation after preparation (in embodiments in which the thermochromic formulation includes an epoxy resin, preparation includes curing) and substantially drying (drying to a degree necessary to form a layer or permanent coating but allowing sufficient liquid to remain to enable exhibiting a thermoresponsive phase transition).

As used herein, a “dark color” is a color from the visible color space that has an electromagnetic radiation absorption greater than the average electromagnetic radiation absorption for the visible color space.

Embodiments of devices using thermochromic materials, where the thermochromic materials are stable for long time exposure to UV light and heat, have higher index of refraction, can be produced cost-effectively at large scale for large surface coating, allow convenient installation and a fast color switch are disclosed hereinbelow.

In one embodiment, the apparatus of these teachings includes a first layer, a second layer; the second layer being disposed a distance apart from the first layer and a solution of thermosensitive polymer and high refractive index nanoparticles functionalized with the thermosensitive polymer, the thermosensitive polymer exhibiting a thermoresponsive phase transition at a predetermined temperature, the solution being disposed in a space defined by the distance between the first layer and the second layer, the predetermined temperature being a temperature resulting from conduction/absorption of electromagnetic radiation in one of the first layer, the second layer or the solution, at least one layer from the first and second layers being substantially transparent.

In one instance, the thermosensitive polymer is Poly(N-isopropylacrylamide) (P-NIPAM). In P-NIPAM, the thermoresponsive phase transition takes place at the lower critical solution temperature (LCST) and the LCST can be tuned by variation in co-monomer content.

Other thermosensitive polymers, such as Elastin-like polypeptides (ELPs, for example, pentapeptide repeats of Val-Pro-Gly-Xaa-Gly (Xaa being any amino acid except proline)), which exhibit a thermoresponsive phase transition that can be adjusted to a relevant temperature, and diblock copolymer methoxy PEG-co-poly(e-caprolactone) (mPEG-PCL) materials, which exhibit a sol-gel-sol transition that occurs at a temperature dependent on the PCL length, are within the scope of these teachings.

In one instance, in the high refractive index nanoparticles are TiO₂ nanoparticles, which have an index of refraction over there visible range of about 3.38 to about 2.8. In another instance, the high refractive index nanoparticles are ZnO nanoparticles, which have an index of refraction over the visible range of about 2. Both TiO₂ nanoparticles and ZnO nanoparticles are UV absorbing. VO₂ or W-doped VO₂ nanoparticles, which have an index of refraction over the visible range of about 2.9, can also be used in embodiments of these teachings.

A characteristic length of the high refractive index nanoparticles is selected in order to substantially prevent scattering of sunlight by the high refractive index nanoparticles when the solution is in a clear state. In one instance, the characteristic length (for example, the diameter) is less than 20 nm.

In one instance, the distance between the first layer and the second layer is between about 100 micrometer to about 1000 micrometer.

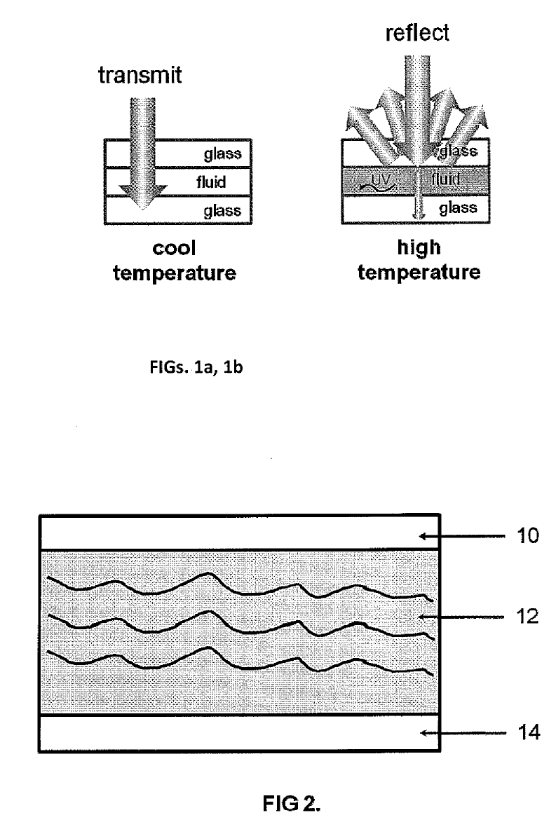

FIGS. 1a, 1b illustrate the operation of one embodiment of the device of these teachings. The device includes two panes of glass, and a polymer/nanoparticle fluid that is disposed between them. The reversible light scattering mechanism is based on the phase separation of thermal sensitive polymer/nanoparticle from the fluid, varying from transparent to substantially opaque. When the temperature is below lower critical solution temperature (LSCT), as shown in FIG. 1a, the fluid is transparent and the sunlight can transmit. When the temperature is equal to or above LSCT, as shown in Fig. Tb, the fluid automatically turns to opaque and scatters most of the sunlight. The UV light is absorbed by the nanoparticles in the fluid.

In one embodiment, the first and second layers have substantially a predetermined length; the predetermined length spanning from a first end to a second end of the first and second layers. The device, in that embodiment, further includes a first sealing component disposed between the first and second layers at the first end. The device can also include a second sealing component disposed between the first and second layers at the second end, where the second sealing component has a sealable opening allowing filling the space defined by the distance between the first layer and the second layer with the solution of thermosensitive polymer and high refractive index nanoparticles functionalized with the thermosensitive polymer. In one instance, the first sealing component and the second sealing component can be an adhesive (such as, but not limited to, glue), the opening in the second sealing component being sealed with another (or the same) adhesive.

In one embodiment, the second layer is rendered capable of absorbing electromagnetic radiation in a predetermined wavelength range. In one instance, second layer is rendered capable of absorbing electromagnetic radiation in a predetermined wavelength range by depositing an absorbing material on the surface. In one instance, the material is a substantially black coating.

FIG. 2 shows an embodiment of the device of these teachings. A cell was constructed using a clear front wall 10 and black painted back wall 14, and a mixture of P-NIPAM and TiO₂ nanoparticles as the fluid 12. Viewed from the top, the cell was black at room temperature below 33° C. and turned to white above 33° C.

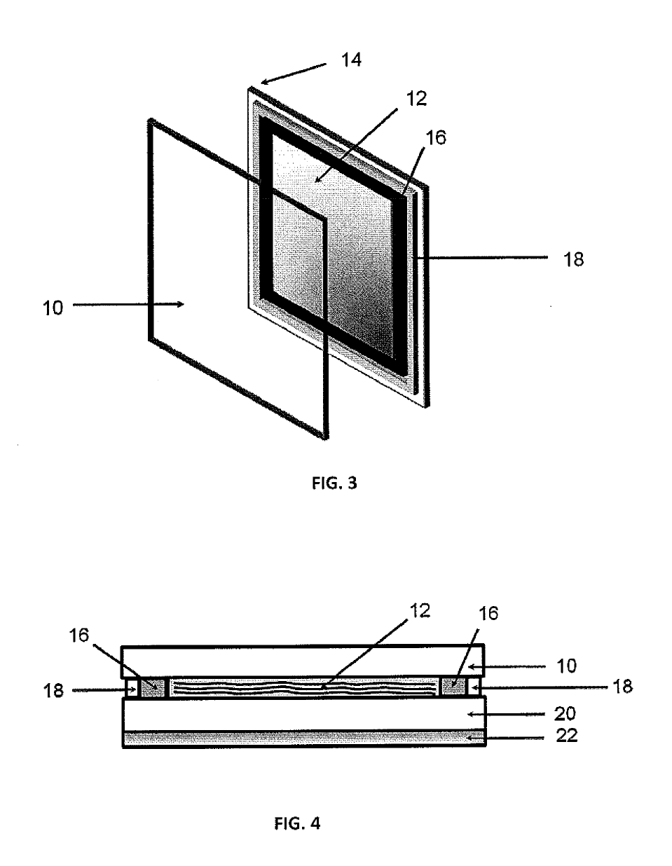

FIG. 3 illustrates a 3-dimensional view of a nanoparticle/polymer fluid based thermochromic cell device of these teachings for smart window applications.

In other embodiments, both the first and the second layer are substantially transparent. In embodiments in which the first and the second layer are substantially transparent, some embodiments include a transparent colored layer disposed on the second layer.

FIG. 4 illustrates a device of these teachings with a color clear background for color changeable decoration window. The solution of thermosensitive polymer and high refractive index nanoparticles functionalized with the thermosensitive polymer is filled in a cell panel with transparent colorless glass 10 and 20 layers on both sides. The color clear background 22 is placed on the outer surface of the inner layer 20 of the panel.

One embodiment of the method of these teachings for changing reflectance of structures includes providing a structure, the structure being as described in the hereinabove disclosed device embodiment, and exposing the structure to an environment including sunlight; the solution of thermosensitive polymer and functionalized high refractive index nanoparticles undergoing a phase transition when the temperature of solution reaches the predetermined temperature, the phase transition converting the solution from substantially transparent to substantially reflecting due to scattering.

One embodiment of the method of these teachings for fabricating a structure that changes reflectance includes disposing two layers a predetermined distance away from each other, each layer spanning from a first end to a second end, at least one layer from the two layers being substantially transparent, disposing a first sealing component at the first end, disposing a second sealing component at the second end, the second sealing component having a sealable opening allowing filling a space between the two layers with a liquid, filling the space between the first layer and the second layer with a solution of thermosensitive polymer and high refractive index nanoparticles functionalized with the thermosensitive polymer, the thermosensitive polymer exhibiting a thermoresponsive phase transition at a predetermined temperature, the predetermined temperature being a temperature resulting from exposing, to an environment including sunlight, at least one of the two layers or the solution, and sealing the opening. The solution of thermosensitive polymer and functionalized high refractive index nanoparticles undergoes a phase transition when the temperature of solution reaches the predetermined temperature, the phase transition converting the solution from substantially transparent to substantially reflecting due to scattering.

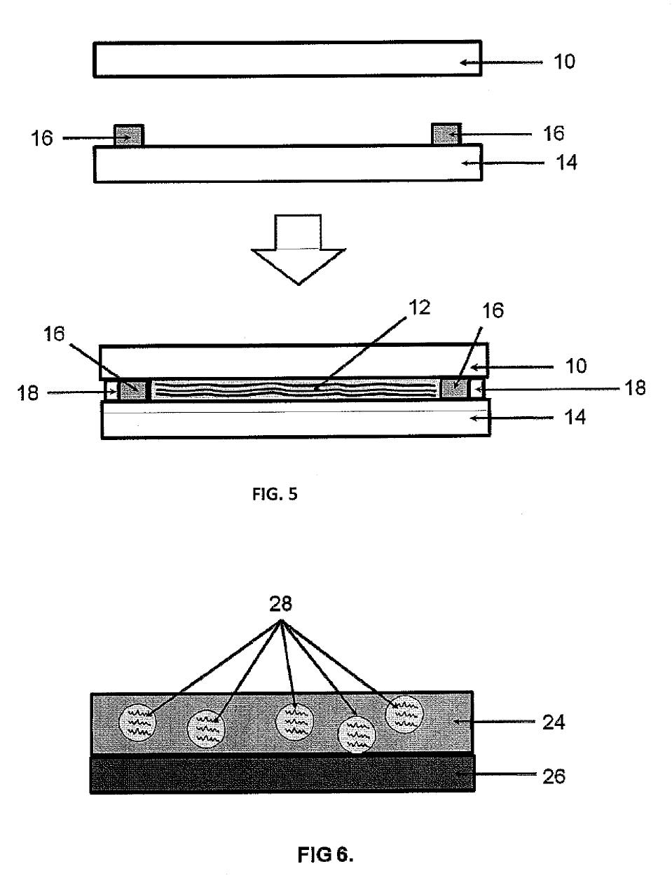

FIG. 5 illustrates the method for fabricating an embodiment of the nanoparticle/polymer fluid based thermochromic cell device of these teachings for smart window applications, using a cross sectional view. The cell device was made by a glass cell having two layers 10, 14 containing one layer 10 being substantially transparent (clear) and another layer 14 having a painted black wall, with a spacer 16 in the middle, creating a distance between the two layers 10, 14. The cell was sealed by glue sealant 18 at the top and bottom, with a 1 cm gap on the top for addition of the fluid. The fluid of P-NIPAM and TiO₂ nanoparticles 12 was filled in the cell by pipette dropping or vacuum pumping through the gap on the top. After addition, the gap was completely sealed by the glue sealant 18.

Although FIG. 5 illustrates the fabrication of one embodiment of the device of these teachings, it should be noted that these teachings are not limited to only that embodiment.

Methods for fabricating other embodiments of the device of these teachings, as disclosed herein above, are also within the scope of these teachings.

An embodiment of the formulation of these teachings includes a solvent, a thermosensitive polymer and high refractive index nanoparticles functionalized with the thermosensitive polymer, the thermosensitive polymer and high refractive index nanoparticles being in solution in the solvent, the thermosensitive polymer exhibiting a thermoresponsive phase transition at a predetermined temperature, the predetermined temperature being a temperature obtainable from exposing, to an environment including sunlight, the solution, and a polymer resin, the formulation being adapted for deposition onto a surface. In one instance, the polymer resin is an epoxy resin. It should be noted that formulations also including stabilizing agents, such as dispersants, and/or rheology modifiers, are also within the scope of these teachings.

One embodiment of a thermochromic coated object of these teachings includes an article, a surface of the article constituting a substrate and a thermochromic coating applied to the substrate, the thermochromic coating resulting from the formulation disclosed hereinabove. In one instance, these teachings not being limited to only that instance, the thermosensitive polymer is Poly(N-isopropylacrylamide) (P-NIPAM) and the high refractive index nanoparticles are TiO₂ nanoparticles or ZnO nanoparticles. A characteristic length of the high refractive index nanoparticles is selected in order to substantially prevent scattering of sunlight by the high refractive index nanoparticles when the solution is in a clear state. In one instance, the characteristic length (such as, for example, the diameter) is less than 20 nm.

In one instance, the polymer resin is an epoxy resin. In embodiments in which the thermochromic formulation includes an epoxy resin, preparation of the coating includes curing.

In one embodiment, the substrate is rendered capable of absorbing electromagnetic radiation in a predetermined wavelength range by depositing an absorbing material on the substrate. In one instance, wherein the absorbing material is a dark color coating.

In one instance, not a limitation of these teachings, the object can be a roof or roof component.

One embodiment of the method of these teachings for changing reflectance of an object includes providing a thermochromic coated object, where the object includes an article, a surface of the article constituting a substrate and a thermochromic coating applied to the substrate, the thermochromic coating resulting from the formulation disclosed hereinabove, exposing the structure to an environment including sunlight, the solution of thermosensitive polymer and functionalized high refractive index nanoparticles in the formulation undergoing a phase transition when the temperature of the solution reaches the predetermined temperature, the phase transition converting the solution from substantially transparent to substantially reflecting due to scattering.

In one embodiment, the method also includes depositing an absorbing material on the substrate. In one instance, the material is a dark color coating.

In one instance, the polymer resin is an epoxy resin and providing the thermochromic coated object includes curing the epoxy resin.

In one instance, the thermosensitive polymer is Poly(N-isopropylacrylamide) (P-NIPAM) and the high refractive index nanoparticles are TiO₂ nanoparticles or ZnO nanoparticles. A characteristic length of the high refractive index nanoparticles is selected in order to substantially prevent scattering of sunlight by the high refractive index nanoparticles when the solution is in a clear state. In one instance, the characteristic length (for example, the diameter) is less than 20 nm. In one instance, the high refractive index nanoparticles are UV absorbing.

One embodiment of the method of these teachings for fabricating an object that changes reflectance includes applying to a surface of an article, the surface constituting a substrate, the formulation disclosed hereinabove, and drying the applied formulation in order to form a coating on the substrate. In one embodiment, the method also includes depositing an absorbing material on the substrate before applying the formulation. In one instance, the absorbing material is a dark color coating. In embodiments where the polymer resin is an epoxy resin, the method also includes curing the epoxy resin. In one instance, the thermosensitive polymer in the formulation is Poly(N-isopropylacrylamide) (P-NIPAM) and the high refractive index nanoparticles in the formulation are TiO₂ nanoparticles or ZnO nanoparticles. A characteristic length of the high refractive index nanoparticles is selected in order to substantially prevent scattering of sunlight by the high refractive index nanoparticles when the solution is in a clear state. In one instance, the characteristic length (for example, the diameter) is less than 20 nm. In one instance, the high refractive index nanoparticles are UV absorbing (both TiO₂ nanoparticles and ZnO nanoparticles are UV absorbing).

FIG. 6 illustrates a thermochromic coated object of these teachings, a roof with a thermochromic roof coating, and the method of making the object, the roof with the thermochromic roof coating. The fluid of P-NIPAM and TiO₂ nanoparticles was mixed with polymer resin of in the embodiment shown, but not a limitation of these teachings, epoxy 24 and the mixture was coated on a painted roof 26. After curing and drying, the fluid forms droplets 28 in the polymer due to phase separation. The color changing of the roof coating is due to the thermochromic property of the P-NIPAM and TiO₂ nanoparticle fluid droplet embedded in the polymer coating

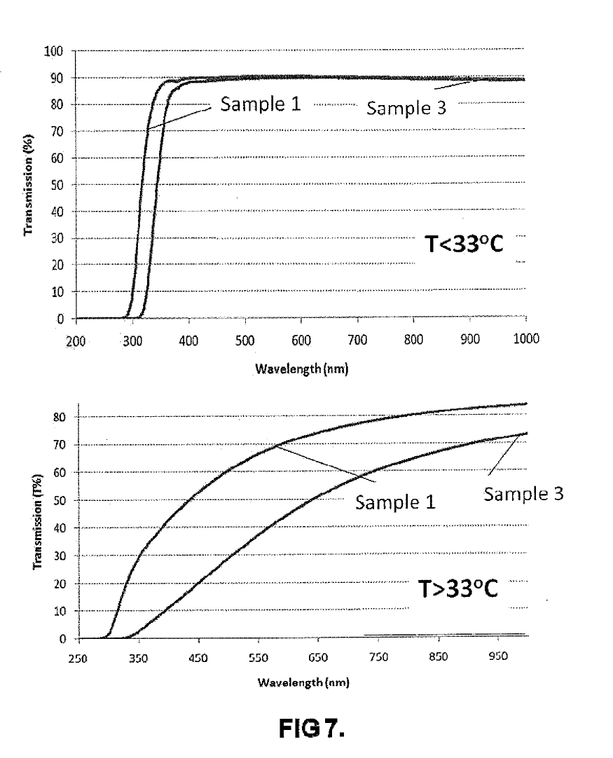

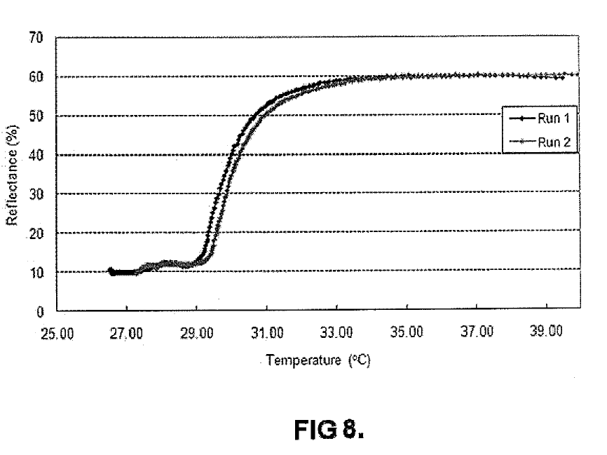

FIG. 7 illustrates Transmission curves of P-NIPAM (sample 1) and P-NIPAM+TiO2 NP (sample 3) below 33° C. (top) and above 33° C. (bottom). As can be seen from these curves, below 33° C. the light transmission difference of the two samples is negligible. However, the UV absorption of TiO₂ nanoparticles can be identified by the cut-off red-shift. When the temperature is above 33° C., the enhanced light scattering by the nanoparticles can be clearly seen from the transmitted images and reduced transmission.

FIG. 8 illustrates temperature dependence of the reflectivity of the front surface of the thermochromic cell device of FIG. 2. The total reflectivity of the thermochromic cell device at different temperatures was measured by using an integrating sphere and a 532 nm laser as the light source. As can be seen from this figure, the surface reflectance jumps from 10% to ˜60% when the sample temperature increases from 29° C. to 34° C. The measurements were performed twice with repeatability.

In order to better illustrate the present teachings, an exemplary embodiment is disclosed hereinbelow. It should be noted that these teachings are not limited to this exemplary embodiment and that numerical values presented are presented for illustration purposes and not in order to limit the present teachings.

The water soluble TiO₂ nanoparticles were synthesized as follows: 26 ml titanium tetraisopropoxide (TTIP) was added into 6 ml HNO₃ and 308 ml water solution. Immediately a white solid was formed. The white suspension was stirred for half hour at room temperature before warmed up and kept at 90° C. for 1 hour for the sol gel synthesis of TiO₂ nanoparticles. After reaction, the heating plate was turned off and let the reaction solution cool to room temperature. The formation of clear solution showed that the yield of soluble TiO₂ was near to complete. The measured TiO₂ concentration was 2.1 w % which is close to 2.09 w % theoretical TiO₂ concentration. As prepared TiO₂ aqueous solution was kept in the glass flask under ambient conditions for later use. No noticeable precipitation was found after the TiO₂ was stored at ambient conditions for 3 months.

The following is the sol gel reaction mechanism for TiO₂ synthesis.

Hydrolysis

Ti[OCH(CH₃)₂]₄+H₂O═HOTi[OCH(CH₃)₂]₃+(CH₂)₂CHOH

Condensation

[(CH₃)₂HCO]₃TiHO+HOTi[OCH(CH₃)₂]₃═[(CH₃)₂HCO]₃Ti—O—Ti[OCH(CH₃)₂]₃+H₂O

[(CH₃)₂HCO]₃TiHO+HOTi[OCH(CH₃)₂]₄═[(CH₃)₂HCO]₃Ti—O—Ti[OCH(CH₃)₂]₃+(CH₃)₂COH

The TiO₂ nanoparticle/P-NIPAM fluid was prepared by mixing 25 ml of P-NIPAM aqueous solution with 25 ml of as produced TiO₂ nanoparticle solution at room temperature. The TiO₂ capped with P-NIPAM was separated by centrifuge at 5500 rpm for 10 minutes at 38° C., which is higher than the LSCT temperature of P-NIPAM at 32° C. The precipitate was dissolved in DI-Water at 20° C. This procedure was repeated twice to remove free TiO₂ nanoparticles that are not tethered (funtionalized) with P-NIPAM. Three different weigh ratio of P-NIPAM to TiO₂ in water was tested, as shown in Table-1.

TABLE 1
TiO₂ nanoparticles P-NIPAM functionalization conditions

| | TiO₂ As prepared | P-NIPAM | |
|---|---|---|---|
| Sample | (2% in water) (ml) | (5% in water) (ml) | Appearance (20° C.) |
| 1 | 1 | 0.5 | Clear |
| 2 | 1 | 1 | Clear |
| 3 | 1 | 2 | Clear |

The phase transition temperature of P-NIPAM functionalized TiO₂ was tested in test tube using water bath at different temperature. The TiO₂/P-NIPAM solution turns from clear water solution into turbid at temperature at 32-34° C. and higher. The clear-turbid transition is reversible and repeatable. The TiO₂/P-NIPAM has the same lower critical solution temperature (LSCT) as neat P-NIPAM. So the free P-NIPAM can't be separated from TiO₂/P-NIPAM by temperature.

The exemplary embodiment of the cell device for smart window was prepared as follows: two 3 mm thick glass with size of 10′×12′ was laminated and sealed with glue, with a spacer of 50 to 1000 μm (not a limitation of these teachings) in the middle of cell. During sealing, an opening of about 1 cm was left at the top of cell for fluid filling. After drying of the sealant, the TiO₂/P-NIPAM solution was filled through the opening into the cell with a pipette slowly to guarantee the removal of the bubbles. Once the cell was completely filled, the opening was sealed with glue to make sure no leakage left. After drying, the cell device is ready for testing. Thermochromic test showed the temperature difference in front of and behind the cell device is about 10° C.

In making the cell device with color background for color changeable decoration window, a plastic sheet with desired color was disposed on the back side of the cell device produced as described above.

An exemplary embodiment of a roof with thermochromic coating was made as follows: The roof was first painted in a dark color. After drying, the mixture of fluid of P-NIPAM/TiO₂ nanoparticles and polymer resin of epoxy (also referred to as, the formulation) was sprayed on the top of painted roof. The fluid of P-NIPAM/TiO₂ nanoparticles formed droplets when the formulation was cured and dried. The color changing of the roof is due to the thermochromic property of the P-NIPAM and TiO₂ nanoparticle fluid droplet embedded in the formulation.

In these teachings, the nanoparticle and polymer are stable for long time exposure to UV light and heat. For embodiments where the high refractive index nanoparticles are UV absorbing, UV light will be absorbed by nanoparticles. For these teachings, the index of refraction of nanoparticles is greater than 1.8. In the embodiments of these teachings, the synthesis of both nanoparticle and polymer is simple, cheap, and cost effective for industrial scale up. In the embodiments of these teachings, no solid phase coating required (the fluid can be introduced into the space between layers and can be simply refilled and recycled) and no electric power is needed to operate the switch. The color change appears within seconds when the predetermined temperature is reached.

For the purposes of describing and defining the present teachings, it is noted that the tens “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Although the invention has been described with respect to various embodiments, it should be realized these teachings are also capable of a wide variety of further and other embodiments within the spirit and scope of the appended claims.

What is claimed is:

1. A device comprising:
a first layer;
a second layer; the second layer being disposed a distance apart from the first layer; and
a solution of thermosensitive polymer and high refractive index nanoparticles functionalized with the thermosensitive polymer, the thermosensitive polymer exhibiting a thermoresponsive phase transition at a predetermined temperature;
the solution being disposed in a space defined by the distance between the first layer and the second layer; said predetermined temperature being a temperature resulting from conduction/absorption of electromagnetic radiation in one of said first layer, said second layer or said solution;
at least one layer from the first and second layers being substantially transparent.

2. The device of claim 1 wherein the thermosensitive polymer is Poly(N-isopropylacrylamide) (P-NIPAM).

3. The device of claim 2 where in the high refractive index nanoparticles are TiO₂, ZnO, VO₂ or W-doped VO₂ nanoparticles.

4. The device of claim 1 wherein a characteristic length of the high refractive index nanoparticles is selected in order to substantially prevent scattering of sunlight by the high refractive index nanoparticles when the solution is in a clear state.

5. The device of claim 1 wherein the first and second layers have substantially a predetermined length; the predetermined length spanning from a first end to a second end of the first and second layers; the device further comprising a first sealing component disposed between the first and second layers at the first end.

6. The device of claim 5 further comprising a second sealing component disposed between the first and second layers at the second end; the second sealing component having a sealable opening allowing filling the distance between the first layer and the second layer with said solution.

7. The device of claim 6 wherein the first sealing component and the second sealing component comprise an adhesive; the opening in the second sealing component being sealable with another adhesive.

8. The device of claim 1 wherein the high refractive index nanoparticles are UV absorbing.

9. The device of claim 1 wherein the second layer is rendered capable of absorbing electromagnetic radiation in a predetermined wavelength range.

10. The device of claim 9 wherein a surface of the second layer is rendered capable of absorbing electromagnetic radiation in a predetermined wavelength range by depositing an absorbing material on the surface.

11. The device of claim 10 wherein the material is a substantially black coating.

12. The device of claim 1 wherein both the first and the second layer are substantially transparent.

13. The device of claim 12 further comprising a transparent colored layer disposed on the second layer.

14. A method for fabricating a structure that changes reflectance, the method comprising the steps of:
disposing two layers a predetermined distance away from each other, each layer spanning from a first end to a second end; at least one layer from the two layers being substantially transparent;
disposing a first sealing component at the first end;
disposing a second sealing component at the second end; the second sealing component having a sealable opening allowing filling a space between the two layers with a liquid;
filling the space between the first layer and the second layer with a solution of thermosensitive polymer and high refractive index nanoparticles functionalized with the thermosensitive polymer, the thermosensitive polymer exhibiting a thermoresponsive phase transition at a predetermined temperature; said predetermined temperature being a temperature resulting from exposing, to an environment including sunlight, at least one of the two layers or said solution; and
sealing the opening;
the solution of thermosensitive polymer and functionalized high refractive index nanoparticles undergoing a phase transition when the temperature of solution reaches said predetermined temperature, the phase transition converting the solution from substantially transparent to substantially reflecting due to scattering.

15. A formulation comprising:
a solvent;
a thermosensitive polymer and high refractive index nanoparticles functionalized with the thermosensitive polymer, the thermosensitive polymer and high refractive index nanoparticles being in solution in the solvent; the thermosensitive polymer exhibiting a thermoresponsive phase transition at a predetermined temperature; the predetermined temperature being a temperature obtainable from exposing, to an environment including sunlight, the solution; and
a polymer resin;
the formulation being adapted for deposition onto a surface.

16. The formulation of claim 15 wherein the polymer resin is an epoxy resin.

17. A thermochromic coated object comprising:
an article, a surface of the article constituting a substrate; and
a thermochromic coating applied to the substrate, the thermochromic coating resulting from the formulation of claim 15.

18. The thermochromic coated object of claim 17 wherein the thermosensitive polymer is Poly(N-isopropylacrylamide) (P-NIPAM).

19. The thermochromic coated object of claim 18 wherein the high refractive index nanoparticles are TiO₂, ZnO, VO₂ or W-doped VO₂ nanoparticles.

20. The thermochromic coated object of claim 17 wherein a characteristic length of the high refractive index nanoparticles is selected in order to substantially prevent scattering of sunlight by the high refractive index nanoparticles when the solution is in a clear state.

21. The thermochromic coated object of claim 17 wherein the high refractive index nanoparticles are UV absorbing.

22. The thermochromic coated object of claim 17 wherein the polymer resin is an epoxy resin.

23. The thermochromic coated object of claim 18 wherein the substrate is rendered capable of absorbing electromagnetic radiation in a predetermined wavelength range by depositing an absorbing material on the substrate.

24. The thermochromic coated object of claim 23 wherein the absorbing material is a dark color coating.

25. A method for fabricating an object that changes reflectance, the method comprising the steps of:
applying to a surface of an article, the surface constituting a substrate, the formulation of claim 16; and
drying the applied formulation in order to form a coating on the substrate.

26. The method of claim 25 further comprising the step of depositing an absorbing material on the substrate before applying the formulation.

27. The method of claim 26 wherein the absorbing material is a dark color coating.

28. The method of claim 25 wherein the polymer resin is an epoxy resin; and wherein the method further comprises the step of curing the epoxy resin.
